(19) United States
(12) Patent Application Publication
(10) Pub. No.: US 2006/0079325 A1
(43) Pub. Date: Apr. 13, 2006

(54) Avatar database for mobile video communications

(75) Inventors: Miroslav Trajkovic, Ossining, NY (US); Yun-Ting Lin, Ossing, NY (US); Philomin Vasanth, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/538,102

(22) PCT Filed: Dec. 4, 2003
(86) PCT No.: PCT/IB03/05685

§ 371 Date: Jun. 8, 2005

Related U.S. Application Data
(60) Provisional application No. 60/432,800, filed on Dec. 12, 2002.

(51) Int. Cl. A63F 13/00; A63F 9/24

(52) U.S. Cl. 463/31; 707/3; 715/752

(57) ABSTRACT

A method and system for avatar mobile video communications are disclosed. Since the creation and realistic driving of avatars may not be done fully automatically with in a mobile communication device (e.g., a cellular phone), an avatar database is provided along with realistic driving mechanisms. Mobile callers may select appropriate downloadable avatars for using during a mobile video communication. The avatar database is provided as a global resource for the mobile video commutation system.

The present invention relates to the field of mobile video communications. More particularly, the invention relates to a method and system including a global avatar database for use with a mobile video communication network.

Video communication networks have made it possible to exchange information in a virtual environment. One way this is facilitated is by the use of avatars. An avatar allows a user to communicate and interact with others in the virtual world.

The avatar can take many different shapes depending the user desires, for example, a talking head, a cartoon, an animal or a three-dimensional picture of the user. To other users in the virtual world, the avatar is a graphical representation of the user. The avatar may be used in the virtual reality when the user controlling the avatar logs on to, or interacts with, the virtual world, e.g., via a personal computer or mobile telephone.

As mention above, a talking head may be a three-dimensional representation of a person's head whose lips move in synchronization with speech. Talking heads can be used to create an illusion of a visual interconnection, even though the connection used is a speech channel.

For example, in audio-visual-speech systems, the integration of a “talking head,” can be used for a variety of applications. Such applications may include, for example, model-based image compression for video telephony, presentations, avatars in virtual meeting rooms, intelligent computer-user interfaces such as e-mail reading and games, and many other operations. An example of such an intelligent user interface is a mobile video communication system that uses a talking head to express transmitted audio messages.

In audio-video systems, audio is processed to get phonemes and timing information, which is then passed, to a face animation synthesizer. The face animation synthesizer uses an appropriate viseme image (from the set of N) to display with the phoneme and morphs from one phoneme to another. This conveys the appearance of facial movement (e.g., lips) synchronized to the audio. Such conventional systems are described in “Miketalk: A talking facial display based on morphing visemes,” T. Ezzat et al., Proc Computer Animation Conf. pp. 96-102, Philadelphia, Pa., 1998, and “Photo-realistic talking-heads from image samples,” E. Cosatto et al., IEEE Trans. On Multimedia, Vol. 2, No. 3, September 2000.

There are two modeling approaches to animation of facial images: (1) geometry based and (2) image based. Image based systems using photo realistic talking heads have numerous benefits which include a more personal user interface, increased intelligibility over other methods such as cartoon animation, and increased quality of the voice portion of such systems.

Three-dimensional (3D) modeling techniques can also be used. Such 3D models provide flexibility because the models can be altered to accommodate different expressions of speech and emotions. Unfortunately, these 3D models are usually not suitable for automatic realization by a computer system. The programming complexities of 3D modeling are increasing as present models are enhanced to facilitate greater realism. In such 3D modeling techniques, the number of polygons used to generate 3D synthesized scenes has grown exponentially. This greatly increases the memory requirements and computer processing power. Accordingly, 3D modeling techniques generally cannot be implemented in devices such as cellular telephones.

Presently, 2D avatars are used for application like Internet chatting and video-e-mail applications. Conventional systems like CrazyTalk and FaceMail combine text to speech applications with avatar driving. A user can choose one of a number of existing avatars or provide his own and adjust face feature points to his own avatar. When text is entered, the avatar will mimic talking which corresponds to the text. However, this simple 2D avatar model does not produce realistic video sequences.

In order to create 3D avatar models, as described above, typically requires a complicate and interactive technique that too difficult for an average user.

Accordingly, an object of the invention is to provide a business model for avatar based real-time video mobile communications.

Another object of the invention is to provide a global recourse database of avatars for use with mobile video communication.

One embodiment of the present invention is directed to a video communication system including a mobile communication network, a mobile communication device including a display that is capable of exchanging information with another communication device via the mobile communication network, and a database including a plurality of avatars. The database is a global resource for the mobile communication network. The mobile communication device can access at least one of the plurality of avatars.

Another embodiment of the present invention is directed to a method for using an avatar for mobile video communication. The method includes the steps of initiating a video communication by a mobile communication device user to another video communication device user, accessing a global resource database including a plurality of avatars and selecting one avatar of the plurality of avatars in the database. The method also includes the step of sending the one avatar to the another video commutation device user.

Still further features and aspects of the present invention and various advantages thereof will be more apparent from the accompanying drawings and the following detailed description of the preferred embodiments.

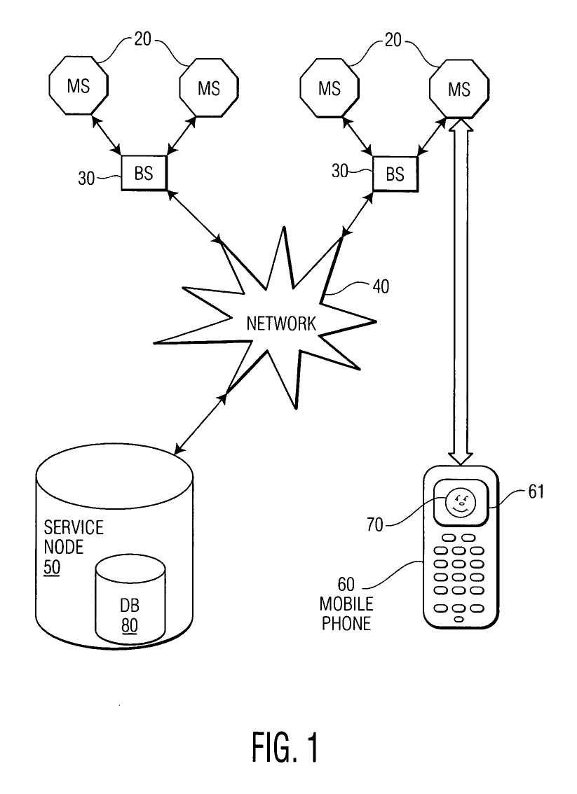

FIG. 1 shows a conceptual diagram of a system in which a preferred embodiment of the present invention can be implemented.

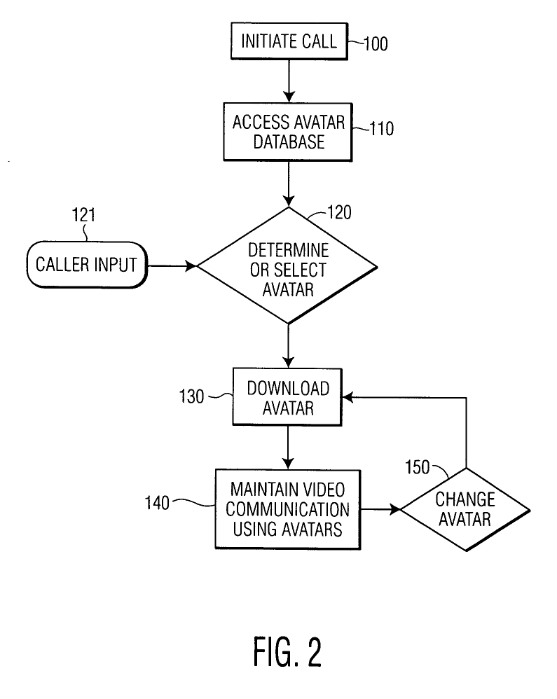

FIG. 2 is a flowchart showing a method in accordance with a preferred embodiment of the invention.

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. Moreover, for purposes of simplicity and clarity, detailed descriptions of well-known devices, circuits, and methods are omitted so as not to obscure the description of the present invention with unnecessary detail.

In FIG. 1, a general view of a mobile communication system 10 is shown. The network includes mobile stations (MS) 20, which can connect to different base station subsystems 30. The base stations (BS) 30 are interconnected by means of a network 40. The network 40 may be a wide area network, such as the public telephone network/cellular switch network, or an Internet router network that routes TCP/IP datagrams.

A variety of service nodes 50 can also be connected via the network 40. As shown, one such service that can be provided is a service for video communications. Service node 50 is configured to provide such video communications and is connected to the network 40 as a global resource.

Each MS 20 includes conventional mobile transmission/reception equipment to enable identification of a subscriber and to facilitate call completion. For example, when a caller attempts to place a cell, i.e., in an area covered by the BS 30 of the network 40, the MS 20 and BS 30 exchange caller information between each other. At this time a list of supported or subscribed services may also exchanged via the network 40. For example, the caller may subscribe to mobile video communications via a mobile telephone 60 with a display 61.

However, as discussed above, for the caller, it may be a major difficulty to create an avatar 70 for use with such mobile video commutations. One embodiment of the present invention is directed to a database 80 of avatars stored in the service note 50 that the caller can access and download as needed. The driving mechanism for the avatar 70 to realistically mimic speech is also provided to the caller.

The database 80 may include a variety of different types of avatars 70, e.g., two-dimensional, three-dimensional, cartoon-like, and geometry- or image-based.

It is also noted that the service node 50 is a global resource for all the BS 30 and the MS 20. Accordingly, each BS 30 and/or MS 20 is not required to store any avatar information independently. This allows for a central point of access for all avatars 70 for update, maintenance and control. A plurality of linked service nodes 70 may also be provided each with a subset all the avatars 60. In such an arrangement, one service node 70 can access data in another service node 70 as needed to facilitate a mobile video communication call.

The database 80 (DB) contains at least an animation library and a coarticulation library. The data in one library may be used to extract samples from the other. For instance, the service node 50 may use data extracted from the coarticulation library to select appropriate frame parameters from the animation library to be provided to the caller.

It is also noted that coarticulation is also performed. The purpose of the coarticulation is to accommodate effects of coarticulation in the ultimate synthesized output. The principle of coarticulation recognizes that the mouth shape corresponding to a phoneme depends not only on the spoken phoneme itself, but also on the phonemes spoken before (and sometimes after) the instant phoneme. An animation method that does not account for coarticulation effects would be perceived as artificial to an observer because mouth shapes may be used in conjunction with a phoneme spoken in a context inconsistent with the use of those shapes.

The service note 50 may also contain animation-synthesis software such as image-based synthesis software. In this embodiment, a customized avatar may be created for the caller. This would typically be done prior to attempting to place a mobile call to another party.

To create a customized avatar, at least samples of movements and images of the caller are captured while a subject is speaking naturally. This may be done via a video input interface within a mobile telephone or audio-image data may be captured in other ways (e.g., via a personal computer) and downloaded to the service node 50. The samples capture the characteristics of a talking person, such as the sound he or she produces when speaking a particular phoneme, the shape his or her mouth forms, and the manner in which he or she articulates transitions between phonemes. The image samples are processed and stored in the animation library of the service node 50.

In another embodiment, the caller may already have a particular avatar that can be provided (uploaded) to the service node 50 for future use.

FIG. 2 shows a flowchart showing access and use of the avatar database 80. In step 100, the caller initiates a mobile telephone call. Information is then exchanged between the MS 20 and the BS 30 identifying the caller as a subscriber of the system 10, as well as determining what services the caller may use. It is noted that the caller may also be identified based upon the unique number associated with the mobile telephone 60.

The avatar database 80 is then accessed in Step 110.

If the caller subscribes to a video communications service, the caller then may have the option of selecting (in step 121) an avatar 70 from the database 80. The caller may have a pre-selected default avatar for use with all calls or have different avatars associated with different parties to be called. For example, a particular avatar may be associated with each pre-programmed speed dial number the caller has programmed.

Once the appropriate avatar 70 is determined (step 120), the service node 50 downloads the avatar 70 in step 130. This avatar is sent to the party to be called as part of the call set-up procedure. This may be performed in a manner similar to the transmission of caller-id type information.

At this time, the service node 50 may also determine that the party to be called has a default avatar to be used for the caller. Once again, the party to be called may have a predetermined default avatar 60 for use with all calls or the default avatar 60 may be based upon a predetermined association (e.g., based upon the caller' telephone number). The predetermined default avatar is sent the caller. If no default avatar can be determined for the party to be called, then another predetermined system default avatar can be sent to the caller.

In step 140, as the call is established and continues, various (e.g., face) parameters of the caller and the party to be called are accessed in the database 80 and sent to the parties to ensure that the avatar 60 is mimicking the received speech and facial expressions accordingly.

During the call (step 150), the caller and/or the party to be called may dynamically change the avatar 60 currently be used.

Various functional operations associated with the system 10 may be implemented in whole or in part in one or more software programs stored in a memory and executed by a processor (e.g., in the MS 20, BS 30 or service node 50).

While the present invention has been described above in terms of specific embodiments, it is to be understood that the invention is not intended to be confined or limited to the embodiments disclosed herein. On the contrary, the present invention is intended to cover various structures and modifications thereof included within the spirit and scope of the appended claims.

1. A video communication system (10) comprising:
a mobile communication network (20,30);
a mobile communication device (60) including a display (61) that is capable of exchanging information with another communication device via the mobile communication network; and
a database (80) including a plurality of avatars (70), the database being a global resource for the mobile communication network,
wherein the mobile communication device can access at least one of the plurality of avatars.

2. The video communication system (10) according to claim 1, wherein mobile communication network is a cellular network including a plurality of mobile stations (20) and at least one base station (30).

3. The video communication system (10) according to claim 2, wherein the mobile communication device is a cellular telephone (60).

4. The video communication system (10) according to claim 1, wherein the plurality of avatars include at least one three-dimensional representation of a human head.

5. The video communication system (10) according to claim 1, wherein the plurality of avatars include at least one two-dimensional representation of a human head (70).

6. The video communication system (10) according to claim 1, wherein the plurality of avatars include at least one image-based representation of a human head (70).

7. The video communication system (10) according to claim 1, wherein the mobile communication device (60) further includes a video input interface.

8. The video communication system (10) according to claim 1, wherein the database (80) is part of a video service node (50) that is communicatively connected to the mobile communication network.

9. The video communication system (10) according to claim 8, wherein the video service node (50) further includes animation-synthesis software to allow a subscriber of the video communication system to create a customized avatar.

10. A method (FIG. 2) for using an avatar for mobile video communication, the method comprising the steps of:
initiating a video communication by a mobile communication device user to another video communication device user;
accessing a global resource database including a plurality of avatars;
selecting one avatar of the plurality of avatars in the database; and
sending the one avatar to the another video commutation device user.

11. The method according to claim 10, wherein the mobile communication device is a cellular telephone.

12. The method according to claim 10, wherein the plurality of avatars include at least one three-dimensional representation of a human head

13. The method according to claim 10, wherein the plurality of avatars include at least one two-dimensional representation of a human head

14. The method according to claim 10, wherein the plurality of avatars include at least one image-based representation of a human head.

15. The method according to claim 10, further comprising the step of allowing mobile communication device user to create a customized avatar by providing video information.

16. The method according to claim 10, wherein the selection step includes using a predetermined default avatar.

17. The method according to claim 16, wherein at least two different predetermined default avatars are used with two video communication device user to be called.

18. The method according to claim 10, further comprising the step of sending a predetermined avatar to the mobile communication device user.
